(19) United States
(12) Patent Application Publication
(10) Pub. No.: US 2025/0128253 A1
(43) Pub. Date: Apr. 24, 2025

(54) Rigid Separation Barrier for a Specimen Collection Container

(71) Applicant: Becton, Dickinson and Company, Franklin Lakes, NJ (US)

(72) Inventors: Arun U. Nair, Denville, NJ (US); Shruti Wigh, Maywood, NJ (US)

(21) Appl. No.: 18/691,584

(22) PCT Filed: Sep. 14, 2022
(86) PCT No.: PCT/US22/43414

§ 371 Date: Mar. 13, 2024

Related U.S. Application Data
(60) Provisional application No. 63/243,897, filed on Sep. 14, 2021.

(51) Int. Cl. B01L 3/00

(52) U.S. Cl. CPC B01L 3/50215; B01L 2300/0618; B01L 2400/0605

(57) ABSTRACT

A specimen collection container assembly including a collection tube, an interior reservoir formed within the collection tube, a gel separation substance provided within the interior reservoir, and a rigid barrier member provided within the interior reservoir. Upon collection of a specimen within the interior reservoir and centrifugation of the collection tube, the specimen is divided into two primary component parts, and the gel separation substance and the rigid barrier member migrate or are otherwise moved to a transition location between the two primary component parts so as to form a physical barrier between a first component part of the specimen and a second component part of the specimen.

### CROSS-REFERENCE TO RELATED APPLICATION

The present application claims priority to U.S. Provisional Application Ser. No. 63/243,897, entitled “Rigid Separation Barrier for a Specimen Collection Container”, filed Sep. 14, 2021, the entire disclosure of which is hereby incorporated by reference in its' entirety.

### BACKGROUND OF THE INVENTION

### Field of the Invention

The present disclosure relates to a small volume specimen collection container assembly for the collection, storage, and transfer of a blood or specimen sample obtained from a patient for medical diagnostic testing. More specifically, the present disclosure relates to a container assembly for the collection of blood samples which incorporates both a gel-based separator and a rigid separation barrier for reliable barrier separation of the blood or specimen components post-centrifugation.

### Description of Related Art

Conventional specimen collection devices according to the prior art (e.g., capillary blood collection devices) typically provide a microtube or collection container having a receiving lip or funnel feature that engages the skin surface of a patient that has been pierced so as to draw a blood sample from the capillaries located just beneath the skin surface. The internal collection cavity or reservoir of such prior art collection containers is typically much smaller than the overall volume of the specimen collection container, as the volume of blood or specimen collected is relatively low (e.g., 800 μL or less). However, the larger overall volume of the collection container allows for compatibility with certain automated processes employed both before and after a specimen is collected, such as, e.g., sorting, centrifugation, analysis, sealing, etc.

As is known in the art, upon centrifugation of a specimen collection container holding a blood sample, the primary components of the blood (i.e., the plasma/serum and the hematocrit comprised primarily of red blood cells) separate by density, with the denser hematocrit settling at the bottom of the interior reservoir, and the less dense plasma/serum collecting thereabove. In many instances, a gel separator substance is also provided in the collection reservoir. The gel separator substance is configured to have a density between that of the plasma/serum and hematocrit. Accordingly, upon centrifugation, the gel separator substance forms a barrier between the plasma/serum and the hematocrit.

However, while the gel separator substance forms an effective barrier between the separated blood components, the physical properties of the gel separator limit its effectiveness as a physical barrier. Thus, when a probe is inserted into the container for sampling and analysis of the plasma/serum, the probe may inadvertently penetrate the gel separator and/or the hematocrit layer, potentially resulting in a contaminated or inaccurate sample.

### SUMMARY OF THE INVENTION

Accordingly, a need exists for a specimen collection container assembly having reliable barrier separation of a small volume blood sample via both a gel separator and a rigid barrier.

In accordance with an embodiment of the present disclosure, a specimen collection container assembly includes a collection tube, an interior reservoir formed within the collection tube, a gel separation substance provided within the interior reservoir, and a rigid barrier member provided within the interior reservoir. Upon collection of a specimen within the interior reservoir and centrifugation of the collection tube, the specimen is divided into two primary component parts. The gel separation substance and the rigid barrier member migrate to a transition location between the two primary component parts so as to form a physical barrier between a first component part of the specimen and a second component part of the specimen.

In certain configurations, the rigid barrier member comprises a floating barrier. In other configurations, the buoyancy of the floating barrier is equal to the buoyancy of the gel separation substance. The rigid barrier member may include a convex upper surface and a concave lower surface. Optionally, the rigid barrier member is configured to contact an internal sidewall of the interior reservoir when the convex upper surface is contacted by a probe member. In certain configurations, the rigid barrier member includes a one-way valve.

In additional configurations, the one-way valve is configured to close when contacted by a probe member. The rigid barrier member may include a locking member. The locking member may retract when subjected to a centrifugal force. Optionally, the rigid barrier member is formed of a plurality of microbeads. In certain configurations, the rigid barrier member is formed of a plurality of micropellets.

In accordance with another embodiment of the present disclosure, a specimen collection container assembly includes a collection tube, an interior reservoir formed within the collection tube, a gel separation substance provided within the interior reservoir, and a rigid barrier member. Upon collection of a specimen within the interior reservoir and centrifugation of the collection tube, the specimen is divided into two primary component parts. The gel separation substance migrates to a transition location between the two primary component parts, and the rigid barrier member is moved to the transition location so as to form a physical barrier between a first component part of the specimen and a second component part of the specimen.

In certain configurations, the rigid barrier member is moved to the transition location by a plunger rod. The plunger rod may be configured to pass at least partially through a cap, and the cap may be selectively couplable to the collection tube. Optionally, the rigid barrier member includes at least one opening formed therethrough. The rigid barrier member may be moved to the transition location by a threaded rod. The threaded rod may be configured to axially move via rotation of a cap, and the cap may be selectively couplable to the collection tube. The rigid barrier member may be moved to the transition location by a probe. Optionally, the assembly may further includea rotatable floor member coupled to the collection tube, a threaded screw member operably coupled to the rotatable floor member, and a plate member coupled to an end of the threaded screw member, wherein the plate member is configured to act as the rigid barrier member.

In accordance with yet another embodiment of the present disclosure, a specimen collection container assembly includes a collection tube, an interior reservoir formed within the collection tube, a gel separation substance provided within the interior reservoir, a fixed rigid barrier member extending from an internal sidewall of the interior reservoir, and a spring-loaded moving floor provided in a bottom portion of the interior reservoir. Upon collection of a specimen within the interior reservoir and centrifugation of the collection tube, the specimen is divided into two primary component parts. The gel separation substance migrates to a transition location between the two primary component parts, and the spring-loaded moving floor moves downward within the interior reservoir such that the fixed, rigid barrier member is positioned at the transition location between a first component part of the specimen and a second component part of the specimen.

Optionally, the spring-loaded moving floor is held in a fixed position after centrifugation by a ratchet member.

In accordance with yet another embodiment of the present disclosure, a specimen collection container assembly includes a collection tube, an interior reservoir formed within the collection tube, a gel separation substance provided within the interior reservoir, and a chemical tablet provided within the interior reservoir, the chemical tablet comprising a hardening agent. Upon collection of a specimen within the interior reservoir and centrifugation of the collection tube, the specimen is divided into two primary component parts, the gel separation substance migrates to a transition location between the two primary component parts, and the hardening agent within the chemical tablet activates and interacts with the gel separation substance to form a rigid barrier member at the transition location between a first component part of the specimen and a second component part of the specimen.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1A is side cross-sectional view of a specimen collection container assembly in accordance with an aspect of the present disclosure in a first pre-centrifugation condition;

FIG. 1B is a side cross-sectional view of the specimen collection container assembly of FIG. 1A in a second pre-centrifugation condition;

FIG. 1C is a side cross-sectional view of the specimen collection container assembly of FIG. 1A in a post-centrifugation condition;

FIG. 1D is a detailed view of a portion of the specimen collection container assembly of FIG. 1C;

FIG. 2A is side cross-sectional view of a specimen collection container assembly in accordance with another aspect of the present disclosure in a first pre-centrifugation condition;

FIG. 2B is a side cross-sectional view of the specimen collection container assembly of FIG. 2A in a second pre-centrifugation condition;

FIG. 2C is a side cross-sectional view of the specimen collection container assembly of FIG. 2A in a post-centrifugation condition;

FIG. 3A is side cross-sectional view of a specimen collection container assembly in accordance with another aspect of the present disclosure in a first pre-centrifugation condition;

FIG. 3B is a side cross-sectional view of the specimen collection container assembly of FIG. 3A in a second pre-centrifugation condition;

FIG. 3C is a side cross-sectional view of the specimen collection container assembly of FIG. 3A in a first post-centrifugation condition;

FIG. 3D is a side cross-sectional view of the specimen collection container assembly of FIG. 3A in a second post-centrifugation condition;

FIG. 4A is side cross-sectional view of a specimen collection container assembly in accordance with another aspect of the present disclosure in a first pre-centrifugation condition;

FIG. 4B is a side cross-sectional view of the specimen collection container assembly of FIG. 4A in a second pre-centrifugation condition;

FIG. 4C is a side cross-sectional view of the specimen collection container assembly of FIG. 4A in a first post-centrifugation condition;

FIG. 4D is a side cross-sectional view of the specimen collection container assembly of FIG. 4A in a second post-centrifugation condition;

FIG. 4E is a side cross-sectional view of the specimen collection container assembly of FIG. 4A in a third post-centrifugation condition;

FIG. 4F is a side cross-sectional view of the specimen collection container assembly of FIG. 4A in a fourth post-centrifugation condition;

FIG. 4G is a partial side cross-sectional view of the specimen collection container assembly of FIG. 4A in a fifth post-centrifugation condition in accordance with another aspect of the present disclosure;

FIG. 4H is a partial side cross-sectional view of the specimen collection container of FIG. 4G in a sixth post-centrifugation condition;

FIG. 5A is side cross-sectional view of a specimen collection container assembly in accordance with another aspect of the present disclosure in a first pre-centrifugation condition;

FIG. 5B is a side cross-sectional view of the specimen collection container assembly of FIG. 5A in a second pre-centrifugation condition;

FIG. 5C is a side cross-sectional view of the specimen collection container assembly of FIG. 5A in a third pre-centrifugation condition;

FIG. 5D is a side cross-sectional view of the specimen collection container assembly of FIG. 5A in a first post-centrifugation condition;

FIG. 5E is a side cross-sectional view of the specimen collection container assembly of FIG. 5A in a second post-centrifugation condition;

FIG. 5F is a partial side cross-sectional view of the gel separator and rigid barrier of FIG. 5E;

FIG. 6A is side cross-sectional view of a specimen collection container assembly in accordance with another aspect of the present disclosure in a first pre-centrifugation condition;

FIG. 6B is a side cross-sectional view of the specimen collection container assembly of FIG. 6A in a second pre-centrifugation condition;

FIG. 6C is a side cross-sectional view of the specimen collection container assembly of FIG. 6A in a first post-centrifugation condition;

FIG. 6D is a side cross-sectional view of the specimen collection container assembly of FIG. 6A in a second post-centrifugation condition;

FIG. 6E is a side cross-sectional view of the rigid barrier of FIGS. 6A-6D;

FIG. 7A is side cross-sectional view of a specimen collection container assembly in accordance with another aspect of the present disclosure in a first pre-centrifugation condition;

FIG. 7B is a side cross-sectional view of the specimen collection container assembly of FIG. 7A in a second pre-centrifugation condition;

FIG. 7C is a side cross-sectional view of the specimen collection container assembly of FIG. 7A in a post-centrifugation condition;

FIG. 8A is side cross-sectional view of a specimen collection container assembly in accordance with another aspect of the present disclosure in a first pre-centrifugation condition;

FIG. 8B is a side cross-sectional view of the specimen collection container assembly of FIG. 8A in a second pre-centrifugation condition;

FIG. 8C is a side cross-sectional view of the specimen collection container assembly of FIG. 8A in a first post-centrifugation condition;

FIG. 8D is a side cross-sectional view of the specimen collection container assembly of FIG. 8A in a second post-centrifugation condition;

FIG. 9A is side cross-sectional view of a specimen collection container assembly in accordance with another aspect of the present disclosure in a first pre-centrifugation condition;

FIG. 9B is a side cross-sectional view of the specimen collection container assembly of FIG. 9A in a second pre-centrifugation condition;

FIG. 9C is a side cross-sectional view of the specimen collection container assembly of FIG. 9A in a first post-centrifugation condition;

FIG. 9D is a side cross-sectional view of the specimen collection container assembly of FIG. 9A in a second post-centrifugation condition;

FIG. 10A is partial side cross-sectional view of a specimen collection container assembly in accordance with another aspect of the present disclosure in a pre-centrifugation condition;

FIG. 10B is a partial side cross-sectional view of the specimen collection container assembly of FIG. 10A in a centrifugation condition;

FIG. 10C is a partial side cross-sectional view of the specimen collection container assembly of FIG. 10A in a post-centrifugation condition;

FIG. 11A is partial side cross-sectional view of a specimen collection container assembly in accordance with another aspect of the present disclosure in a pre-centrifugation condition;

FIG. 11B is a partial side cross-sectional view of the specimen collection container assembly of FIG. 11A in a post-centrifugation condition.

### DETAILED DESCRIPTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present disclosure.

For the purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawings. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

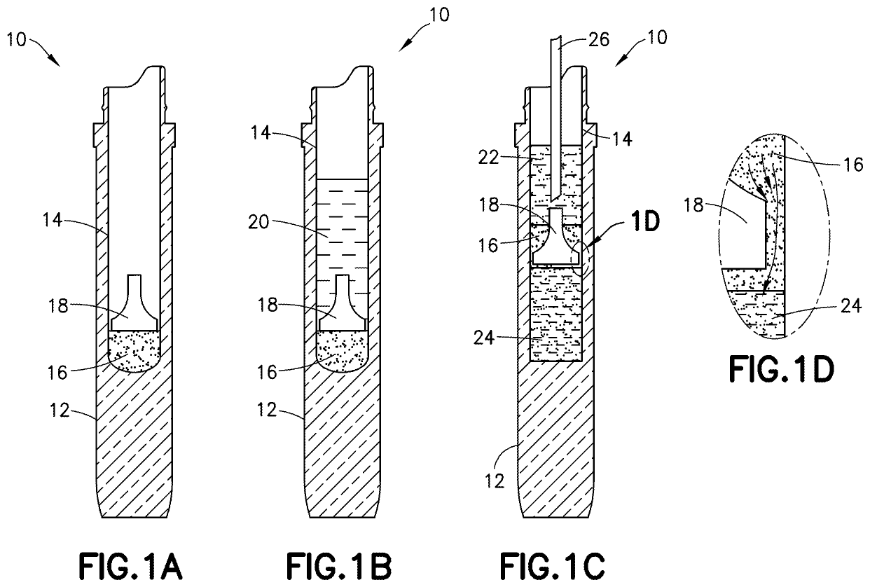

Referring to FIGS. 1A-1D, a specimen collection container assembly 10 in accordance with one aspect of the present disclosure is shown. As shown in FIG. 1A, specimen collection container assembly 10 comprises a collection tube defined by an exterior sidewall 12 and an interior reservoir 14. Accordingly, specimen collection container assembly 10 is configured as a microtube suited for capillary collection of blood samples having overall exterior dimensions conforming to a standard 13 mm×75 mm tube so as to be compatible with standard testing instruments and/or automation processes. The collection tube may be formed by, e.g., injection molding, from suitable plastic or composite material as is known to be suitable by those of ordinary skill in the art.

In some embodiments, interior reservoir 14 has straight or tapered sidewalls so as to provide an adequate column of blood or specimen for separation and analysis, even when the volume of blood or specimen collected is relatively low (e.g., 800 μL or less).

As noted above, FIG. 1A portrays the specimen collection container assembly 10 in a pre-centrifugation state. In such a state, the interior reservoir 14 contains a gel separator substance 16 at a bottom portion thereof. The gel separator substance 16 may be any appropriate substance such as, e.g., a polyester gel.

Furthermore, a rigid float barrier 18 is also provided within the interior reservoir 14. The rigid float barrier 18 may be formed of any appropriate material such as, e.g., a plastic or composite material. Additionally, the rigid float barrier 18 may be formed such that its buoyancy is substantially the same as the buoyancy of the gel separator substance 16. However, in other embodiments, the buoyancy of the rigid float barrier 18 may be less than or greater than that of the gel separator substance 16. While rigid float barrier 18 is illustrated in FIGS. 1A-1C as having a buoy-type shape, the rigid float barrier 18 is not limited to such a shape. As such, it is to be understood that other shapes and/or sizes may be provided in accordance with other embodiments of the present disclosure.

Referring to FIG. 1B, specimen collection container assembly 10 is shown in a second pre-centrifugal state, with a collected blood sample 20 within the interior reservoir 14. As shown in FIG. 1B, prior to centrifugation, the blood sample 20 collects above both the rigid float barrier 18 and the gel separator substance 16.

However, referring to FIG. 1C, upon centrifugation, the blood sample 20 shown in FIG. 1B separates into two primary component parts: a plasma/serum portion 22 and the hematocrit portion 24, with the denser hematocrit portion 24 being forced to the bottom of the interior reservoir 14. Furthermore, with densities between those of the plasma/serum portion 22 and the hematocrit portion 24, centrifugation also causes both the gel separator substance 16 and the rigid float barrier 18 to migrate away from the bottom portion of the interior reservoir 14, with the gel separator substance 16 and rigid float barrier 18 settling in a location at an interface between the component parts of the blood sample, thereby creating an effective barrier between the plasma/serum portion 22 and the hematocrit portion 24.

As is shown in the detailed view of FIG. 1D, the rigid float barrier 18 may be sized such that it does not contact the sidewalls of the interior reservoir 14, thereby allowing fluid to flow past the rigid float barrier 18 during centrifugation. Additionally, the rigid float barrier 18 may also partially embed within the gel separator substance 16 after centrifugation.

Referring again to FIG. 1C, after centrifugation, a technician or other user may utilize a probe 26 in order to obtain a sample from within the interior reservoir 14. As the desired sample is typically the plasma/serum portion 22, the rigid float barrier 18 provides a physical barrier that prevents access by the probe 26 beyond the plasma/serum portion 22, thus protecting against the probe 26 inadvertently entering the hematocrit portion 24. While the probe 26 may contact the rigid float barrier 18, fluid forces and/or a locking mechanism may keep the rigid float barrier 18 in place during sample collection.

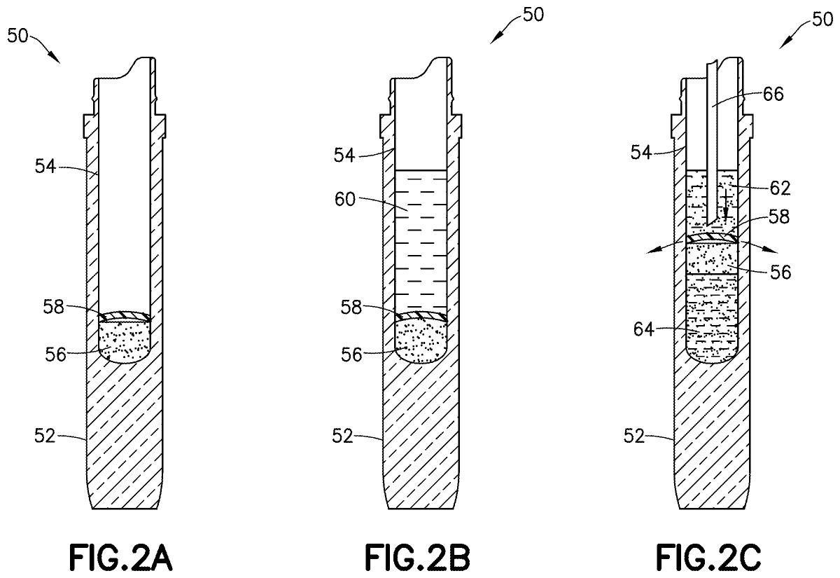

Next, referring to FIGS. 2A-2C, a specimen collection container assembly 50 in accordance with another aspect of the present disclosure is shown. FIG. 2A illustrates the specimen collection container assembly 50 in a first pre-centrifugation condition. Specimen collection container assembly 50 comprises a collection tube defined by an exterior sidewall 52 and an interior reservoir 54. The collection tube may be formed by, e.g., injection molding, from suitable plastic or composite material as is known to be suitable by those of ordinary skill in the art.

The interior reservoir 54 contains a gel separator substance 56 at a bottom portion thereof. Furthermore, a rigid float barrier 58 is also provided within the interior reservoir 54. The rigid float barrier 58 may be formed of any appropriate material such as, e.g., a plastic or composite material. Additionally, the rigid float barrier 58 may be formed such that its buoyancy is substantially the same as the buoyancy of the gel separator substance 56. However, in other embodiments, the buoyancy of the rigid float barrier 58 may be less than or greater than that of the gel separator substance 56.

As shown in FIGS. 2A-2C, rigid float barrier 58 includes a convex upper surface and a concave lower surface. However, it is to be understood that the rigid float barrier 58 is not limited to such a shape, and other shapes and/or sizes may be provided in accordance with other embodiments of the present disclosure.

Referring to FIG. 2B, specimen collection container assembly 50 is shown in a second pre-centrifugal state, with a collected blood sample 60 within the interior reservoir 54. Prior to centrifugation, the blood sample 60 collects above both the rigid float barrier 58 and the gel separator substance 56. However, referring to FIG. 2C, upon centrifugation, the blood sample 60 separates into two primary component parts: a plasma/serum portion 62 and the hematocrit portion 64, with the denser hematocrit portion 64 being forced to the bottom of the interior reservoir 54. Furthermore, with densities between those of the plasma/serum portion 62 and the hematocrit portion 64, centrifugation also causes both the gel separator substance 56 and the rigid float barrier 58 to migrate away from the bottom portion of the interior reservoir 54, with the gel separator substance 56 and rigid float barrier 58 settling in a location at an interface between the component parts of the blood sample to create an effective barrier between the plasma/serum portion 62 and the hematocrit portion 64.

Referring again to FIG. 2C, after centrifugation, a probe 66 may be utilized to obtain a sample from within the interior reservoir 14. As the desired sample is typically the plasma/serum portion 62, the rigid float barrier 58 provides a physical barrier that prevents access by the probe 66 beyond the plasma/serum portion 62, thus protecting against the probe 66 inadvertently entering the hematocrit portion 64. In fact, due to the shape of the rigid float barrier 58 (i.e., the convex upper surface and the concave lower surface), contact by the probe 66 on the upper surface of the rigid float barrier 58 actually acts to lock the rigid float barrier 58 in place, as the outer edges of the rigid float barrier 58 expand radially outward against the inner sidewall of the interior reservoir when subjected to downward force by the probe 66. Such radial expansion by the rigid float barrier 58 prevents downward movement of the rigid float barrier 58 when contacted by probe 66.

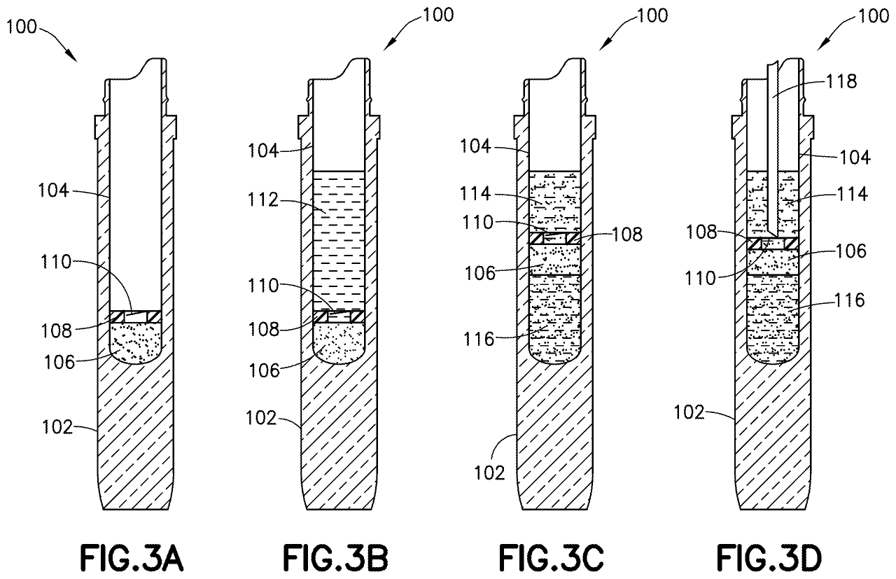

Referring now to FIGS. 3A-3D, a specimen collection container assembly 100 in accordance with another aspect of the present disclosure is shown. FIG. 3A illustrates the specimen collection container assembly 100 in a first pre-centrifugation condition. Specimen collection container assembly 100 includes a collection tube defined by an exterior sidewall 102 and an interior reservoir 104. The collection tube may be formed by, e.g., injection molding, from suitable plastic or composite material as is known to be suitable by those of ordinary skill in the art.

The interior reservoir 104 contains a gel separator substance 106 at a bottom portion thereof, along with a rigid float barrier 108. The rigid float barrier 108 may be formed of any appropriate material such as, e.g., a plastic or composite material. Additionally, the rigid float barrier 108 may be formed such that its buoyancy is substantially the same as the buoyancy of the gel separator substance 106. However, in other embodiments, the buoyancy of the rigid float barrier 108 may be less than or greater than that of the gel separator substance 108.

As shown in FIGS. 3A-3C, rigid float barrier 108 includes a one-way valve 110 formed therein. As will be described in further detail below, the one-way valve 110 is configured to allow fluid (i.e., components of a specimen sample) to pass through the rigid float barrier 108 during centrifugation. However, when contacted from above via, e.g., a probe, the one-way valve 110 is configured to close, thereby preventing access by the probe below the rigid float barrier 108.

Referring to FIG. 3B, specimen collection container assembly 100 is shown in a second pre-centrifugal state, with a collected blood sample 112 within the interior reservoir 104. Prior to centrifugation, the blood sample 112 collects above both the rigid float barrier 108 and the gel separator substance 106. However, referring to FIG. 3C, upon centrifugation, the blood sample 112 separates into two primary component parts: a plasma/serum portion 114 and the hematocrit portion 116, with the denser hematocrit portion 116 being forced to the bottom of the interior reservoir 104. Furthermore, with densities between those of the plasma/serum portion 114 and the hematocrit portion 116, centrifugation also causes both the gel separator substance 106 and the rigid float barrier 108 to migrate away from the bottom portion of the interior reservoir 104, with the gel separator substance 106 and rigid float barrier 108 settling in a location at an interface between the component parts of the blood sample to create an effective barrier between the plasma/serum portion 114 and the hematocrit portion 116.

Referring to FIG. 3D, after centrifugation, a probe 118 may be utilized to obtain a sample from within the interior reservoir 104. As the desired sample is typically the plasma/serum portion 114, the rigid float barrier 108 is configured to provide a physical barrier that prevents access by the probe 118 beyond the plasma/serum portion 114, thus protecting against the probe 118 inadvertently entering the hematocrit portion 116. Specifically, as noted above, the one-way valve 110 of rigid float barrier 108 is configured to close when subjected to contact by the probe 118, which prevents access by the probe 118 below the rigid float barrier 108.

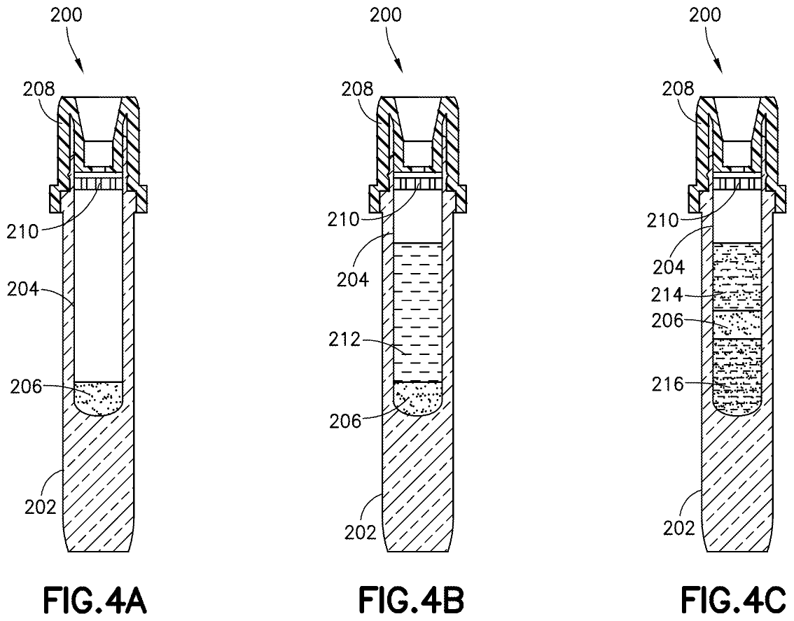

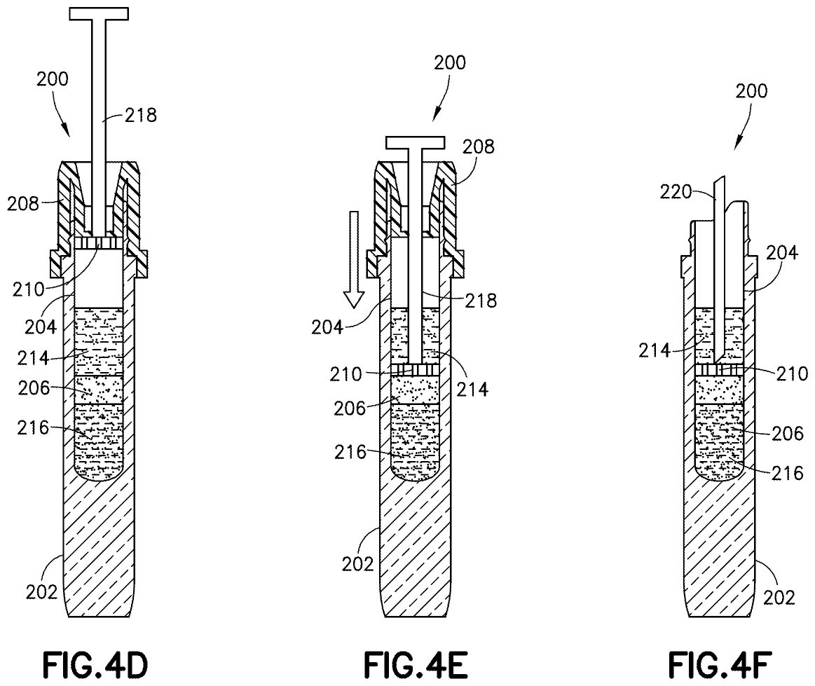

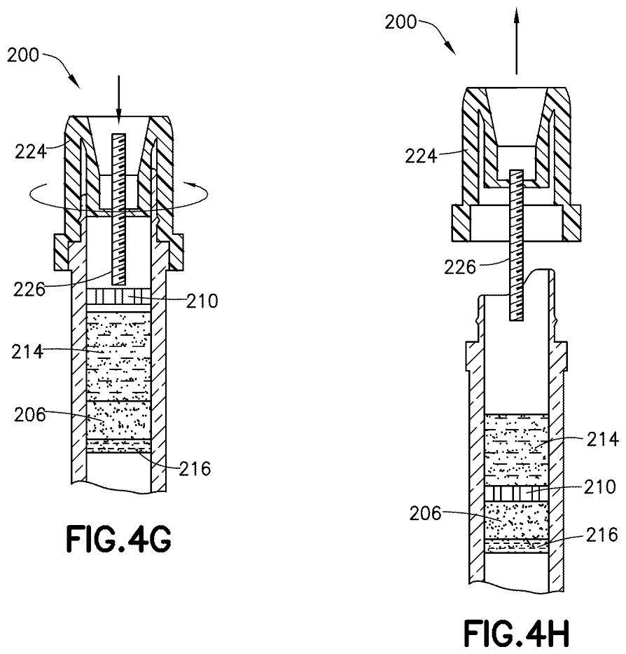

Next, referring to FIGS. 4A-4H, a specimen collection container assembly 200 in accordance with another aspect of the present disclosure is shown. Unlike the rigid float barriers shown and described with respect to FIGS. 1A-3D, specimen collection container assembly 200 includes a user-deployed rigid barrier, as will be described in further detail below.

FIG. 4A illustrates the specimen collection container assembly 200 in a first pre-centrifugation condition. Specimen collection container assembly 200 includes a collection tube defined by an exterior sidewall 202 and an interior reservoir 204. The collection tube may be formed by, e.g., injection molding, from suitable plastic or composite material as is known to be suitable by those of ordinary skill in the art. The interior reservoir 204 further contains a gel separator substance 206 at a bottom portion thereof.

Additionally, specimen collection container assembly 200 includes a cap 208 configured to selectively close access to the interior reservoir 204. Within the cap 208 is a movable rigid barrier 210. The rigid barrier 210 may be formed of any appropriate material such as, e.g., a plastic or composite material.

Referring to FIG. 4B, specimen collection container assembly 200 is shown in a second pre-centrifugal state, with a collected blood sample 212 within the interior reservoir 204. Prior to centrifugation, the blood sample 212 collects above the gel separator substance 206. While shown with cap 208 in place, is to be understood that cap 208 is removed in order to collect blood sample 212 but is replaced by the user before centrifugation.

FIG. 4C illustrates the specimen collection container assembly 200 in a first post-centrifugation condition. In such a condition, the blood sample 212 separates into two primary component parts: a plasma/serum portion 214 and the hematocrit portion 216, with the denser hematocrit portion 216 being forced to the bottom of the interior reservoir 204. Furthermore, with a density between that of the plasma/serum portion 214 and the hematocrit portion 216, centrifugation also causes the gel separator substance 206 to migrate away from the bottom portion of the interior reservoir 204, with the gel separator substance 206 settling in a location at an interface between the component parts of the blood sample to create a non-rigid barrier between the plasma/serum portion 214 and the hematocrit portion 216.

Referring to FIGS. 4D and 4E, specimen collection container assembly 200 may further include a plunger rod 218, with plunger rod 218 configured to pass through an opening (not shown) in the cap 208 in order to contact the rigid barrier 210 held within the cap 210. Thus, after centrifugation, the user may insert the plunger rod 218 (as shown in FIG. 4D) and depress the plunger rod 218 downward in order to move the rigid barrier 210 into a desired position within the interior reservoir 204 (as shown in FIG. 4E). The user may determine the desired position of rigid barrier 210 within the interior reservoir 204 based on one or more of, e.g., a visual confirmation of the location of the gel separator substance 206, physical resistance caused by contact with the gel separator substance 206, etc.

The rigid barrier 210 may include one or more openings formed therein. The one or more openings may be sized to allow a fluid (i.e., plasma/serum portion 214) to pass therethrough, while restricting the passage of more dense materials. Additionally, the rigid barrier 210 may be sized so as to form an interference fit with an interior sidewall of the interior reservoir 204, thereby restricting movement of the rigid barrier 210 once positioned via the plunger rod 218. Furthermore, in some embodiments, the rigid barrier 210 may be held in place via the viscous force of the gel separator substance 206.

As shown in FIG. 4F, after positioning of the rigid barrier 210, the cap 208 and attached plunger rod 218 may be removed, and a probe 220 may be utilized to obtain a sample from within the interior reservoir 204. As the desired sample is typically the plasma/serum portion 214, the rigid barrier 210 is configured to provide a physical barrier that prevents access by the probe 220 beyond the plasma/serum portion 214, thus protecting against the probe 220 inadvertently entering the hematocrit portion 216.

Referring to FIGS. 4G and 4H, an alternative embodiment utilizing the user-positioned rigid barrier 210 is shown. Instead of using the depressed plunger rod 218 to position the rigid barrier 210, as is shown in FIGS. 4D and 4E, the embodiment of FIGS. 4G and 4H utilizes a rotatable cap 224 and threaded rod 226. As shown in FIG. 4G, as the cap 224 is rotated, the threaded rod 226 is configured to interact with an internal surface (not shown) of the cap 224 such that the threaded rod 226 is fed through the cap 224 and extends downward into the interior reservoir 204, pressing the rigid barrier 210 into place is it moves. Once the rigid barrier 210 is in a desired position (i.e., in the position shown in FIG. 4H), the combined cap 224 and threaded rod 226 can be removed to allow access to the specimen sample via, e.g., a probe.

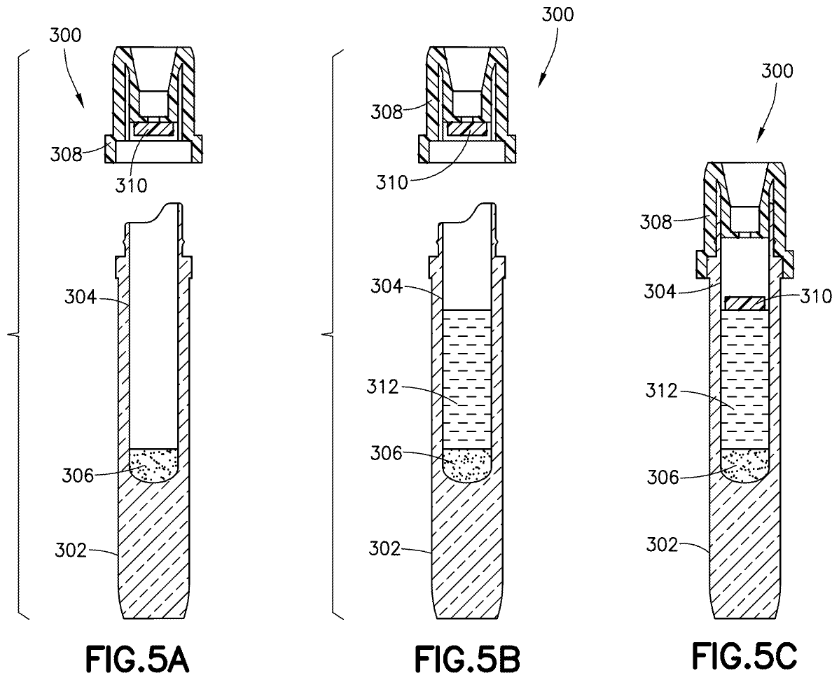

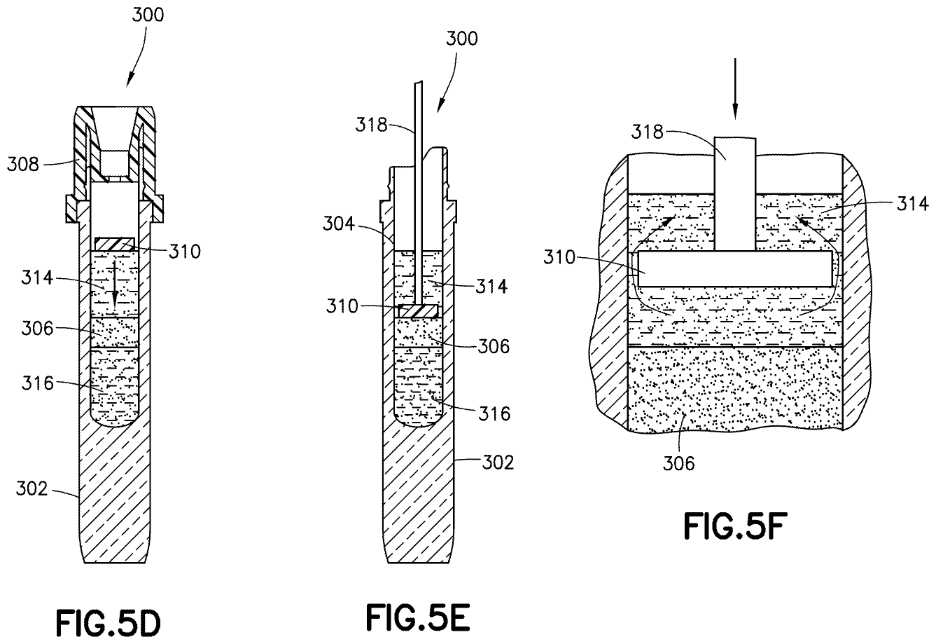

Referring now to FIGS. 5A-5F, a specimen collection container assembly 300 in accordance with another aspect of the present disclosure is shown.

FIG. 5A illustrates the specimen collection container assembly 300 in a first pre-centrifugation condition. Specimen collection container assembly 300 includes a collection tube defined by an exterior sidewall 302 and an interior reservoir 304. The collection tube may be formed by, e.g., injection molding, from suitable plastic or composite material as is known to be suitable by those of ordinary skill in the art. The interior reservoir 304 further contains a gel separator substance 306 at a bottom portion thereof.

Additionally, specimen collection container assembly 300 includes a cap 308 configured to selectively close access to the interior reservoir 304. Within the cap 308 is a movable rigid barrier 310. The rigid barrier 310 may be formed of any appropriate material such as, e.g., a plastic or composite material.

Referring to FIG. 5B, specimen collection container assembly 300 is shown in a second pre-centrifugation state, with a collected blood sample 312 within the interior reservoir 304. Prior to centrifugation, the blood sample 312 collects above the gel separator substance 306. As shown in FIG. 5C, after collection of the blood sample 312, the cap 308 is placed on the container. In accordance with one aspect of the disclosure, placement of the cap 308 causes the rigid barrier 310 to release from the cap 308, with the rigid barrier 310 having a density which allows it to float atop the blood sample 312. In an alternative embodiment, the rigid barrier 310 may remain in the cap 308 when the cap 308 is placed on the container, but the rigid barrier 310 may be released upon centrifugation.

FIG. 5D illustrates the specimen collection container assembly 300 in a first post-centrifugation condition. In such a condition, the blood sample 312 separates into two primary component parts: a plasma/serum portion 314 and the hematocrit portion 316, with the denser hematocrit portion 316 being forced to the bottom of the interior reservoir 304. Furthermore, with a density between that of the plasma/serum portion 314 and the hematocrit portion 316, centrifugation also causes the gel separator substance 306 to migrate away from the bottom portion of the interior reservoir 304, with the gel separator substance 306 settling in a location at an interface between the component parts of the blood sample to create a non-rigid barrier between the plasma/serum portion 314 and the hematocrit portion 316.

However, unlike previous embodiments, centrifugation of the specimen collection container assembly 300 does not cause the rigid barrier 310 to be positioned at an interface between the component parts of the blood sample, and the rigid barrier 310 remains positioned atop the plasma/serum portion 314 after centrifugation, as shown in FIG. 5D. Instead, referring to FIG. 5E, the rigid barrier 310 may be positioned relative to the interface between the plasma/serum portion 314 and the hematocrit portion 316 only by way of a probe 318, which is the same probe that may be utilized to obtain a sample from within the interior reservoir 304. As is shown in FIG. 5F, the rigid barrier 310 may be sized such that gaps are present between the internal sidewall of the interior reservoir 304 and the rigid barrier 310, thereby allowing the plasma/serum portion 314 to flow past the rigid barrier 310 as it is pressed downward by the probe 318. Additionally and/or alternatively, one or more channels or openings may be formed within the rigid barrier 310 to allow the fluid to pass therethrough. Due to the increased viscosity of the gel separator substance 306 and/or the hematocrit portion 316, the rigid barrier 310 would require substantially more force from the probe 318 to continue into and through those substance. As such, movement of the rigid barrier 310 substantially slows and/or stops once in contact with the gel separator substance 306 and/or the hematocrit portion 316. In this way, the rigid barrier 310 is configured to provide a physical barrier that prevents access by the probe 318 beyond the plasma/serum portion 314, thus protecting against the probe 318 inadvertently entering the hematocrit portion 316.

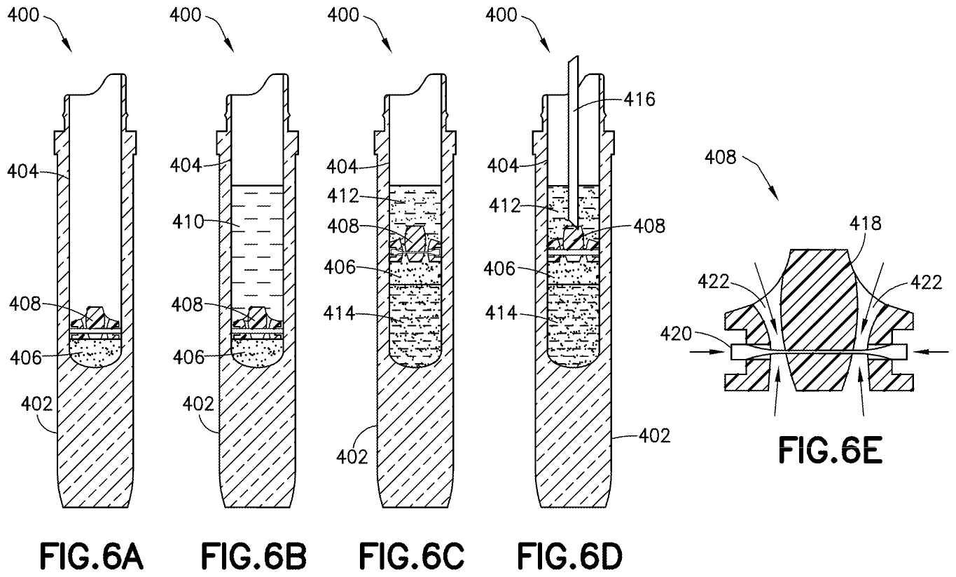

Next, referring to FIGS. 6A-6D, a specimen collection container assembly 400 in accordance with another aspect of the present disclosure is shown. FIG. 6A illustrates the specimen collection container assembly 400 in a first pre-centrifugation condition. Specimen collection container assembly 400 includes a collection tube defined by an exterior sidewall 402 and an interior reservoir 404. The collection tube may be formed by, e.g., injection molding, from suitable plastic or composite material as is known to be suitable by those of ordinary skill in the art.

The interior reservoir 404 contains a gel separator substance 406 at a bottom portion thereof, along with a rigid float barrier 408. The rigid float barrier 408 may be formed of any appropriate material such as, e.g., silicone, plastic, composite, etc. Additionally, the rigid float barrier 408 may be formed such that its buoyancy is substantially the same as the buoyancy of the gel separator substance 406. However, in other embodiments, the buoyancy of the rigid float barrier 408 may be less than or greater than that of the gel separator substance 406.

As shown in FIG. 6E, the rigid float barrier 408 is formed of a core member 418 and a centrifugal locking member 420. The core member 418 includes at least one opening 422 formed therethrough, with the opening(s) 422 configured to allow the passage of fluid through the core member 418. The centrifugal locking member 420 is configured such that the diameter of the locking member 420 expands and contracts dependent upon centrifugal forces. That is, when subjected to centrifugation, the locking member 420 contracts, as is shown in FIG. 6E. However, when not subjected to centrifugation, the locking member 420 radially expands. Accordingly, in a pre- or post-centrifugated condition, the locking member 420 acts to frictionally retain the rigid float barrier 408 relative to the interior sidewall of the interior reservoir 404. Conversely, during centrifugation, the locking member 420 is released from engagement with the interior reservoir 404, enabling locking member 420 to move therein.

Referring to FIG. 6B, specimen collection container assembly 400 is shown in a second pre-centrifugal state, with a collected blood sample 410 within the interior reservoir 404. Prior to centrifugation, the blood sample 410 collects above both the rigid float barrier 408 and the gel separator substance 406. As noted above, the rigid float barrier 408 is locked relative to the interior sidewall of the interior reservoir 404 in this condition.

However, referring to FIG. 6C, upon centrifugation, the blood sample 410 separates into two primary component parts: a plasma/serum portion 412 and the hematocrit portion 414, with the denser hematocrit portion 414 being forced to the bottom of the interior reservoir 404. Furthermore, with densities between those of the plasma/serum portion 412 and the hematocrit portion 414, centrifugation also causes both the gel separator substance 406 and the rigid float barrier 408 (now released form frictional engagement with the interior sidewall) to migrate away from the bottom portion of the interior reservoir 404, with the gel separator substance 406 and rigid float barrier 408 settling in a location at an interface between the component parts of the blood sample to create an effective barrier between the plasma/serum portion 412 and the hematocrit portion 414. After centrifugation, the rigid float barrier 408 returns to a “locked” condition at this interface position.

Referring to FIG. 6D, after centrifugation, a probe 416 may be utilized to obtain a sample from within the interior reservoir 404. As the desired sample is typically the plasma/serum portion 412, the rigid float barrier 408 is configured to provide a physical barrier that prevents access by the probe 416 beyond the plasma/serum portion 412, thus protecting against the probe 416 inadvertently entering the hematocrit portion 414.

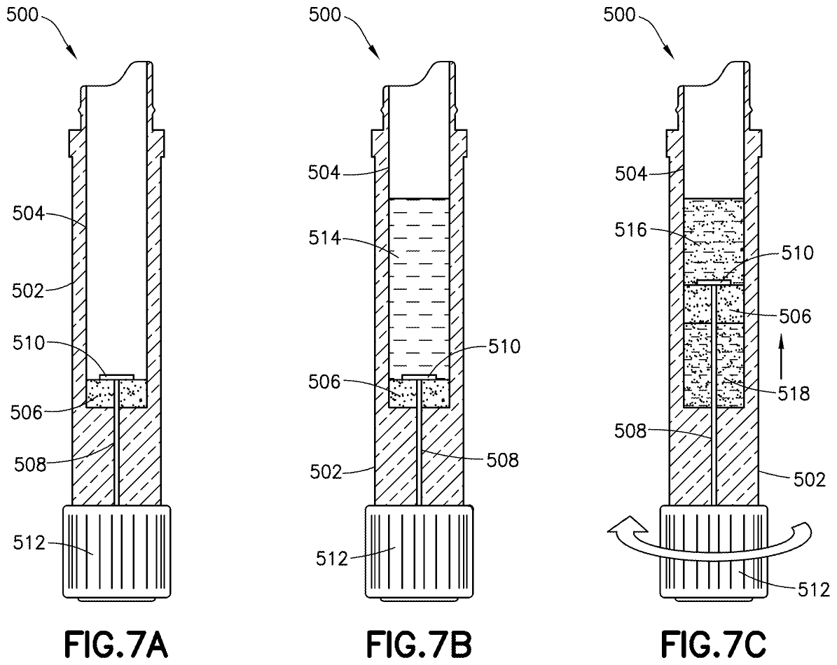

Next, referring to FIGS. 7A-7C, a specimen collection container assembly 500 in accordance with another aspect of the present disclosure is shown.

FIG. 7A illustrates the specimen collection container assembly 500 in a first pre-centrifugation condition. Specimen collection container assembly 500 comprises a collection tube defined by an exterior sidewall 502 and an interior reservoir 504. The collection tube may be formed by, e.g., injection molding, from suitable plastic or composite material as is known to be suitable by those of ordinary skill in the art. The interior reservoir 504 contains a gel separator substance 506 at a bottom portion thereof.

Additionally, a rotatable floor member 512 is provided, with the rotatable floor member 512 being operably coupled to a threaded screw member 508 having a plate member 510 on a distal end thereof. As will be described in more detail below, the rotatable floor member 512 is capable of axially displacing the screw member 508 and plate member 510 within the interior reservoir 504 dependent upon a direction and amount of rotation.

Referring to FIG. 7B, specimen collection container assembly 500 is shown in a second pre-centrifugal state, with a collected blood sample 514 within the interior reservoir 504. Prior to centrifugation, the blood sample 514 collects above both the gel separator substance 506 and the plate member 510. However, referring to FIG. 7C, upon centrifugation, the blood sample 514 separates into two primary component parts: a plasma/serum portion 516 and the hematocrit portion 518, with the denser hematocrit portion 518 being forced to the bottom of the interior reservoir 504. Furthermore, with a density between that of the plasma/serum portion 516 and the hematocrit portion 518, centrifugation also causes the gel separator substance 506 to migrate away from the bottom portion of the interior reservoir 504, with the gel separator substance 506 settling in a location at an interface between the component parts of the blood sample to create a non-rigid barrier between the plasma/serum portion 516 and the hematocrit portion 518.

As the specimen collection container assembly 500 is preferably formed of a substantially transparent or translucent material, the position of the gel separator substance 506 after centrifugation is visually apparent to the user. Accordingly, based on this visual verification of the location of the gel separator substance 506 (and, thus, the transition between plasma/serum portion 516 and the hematocrit portion 518), the user may rotate the rotatable floor member 512 so as to axially displacing the screw member 508 and plate member 510 within the interior reservoir 504 until the plate member 510 is positioned at the between the plasma/serum portion 516 and the gel separator substance 506. In this way, the plate member 510 acts as a rigid barrier capable of preventing access by a probe (not shown) beyond the plasma/serum portion 516, thus protecting against the probe inadvertently entering the hematocrit portion 518 during specimen collection.

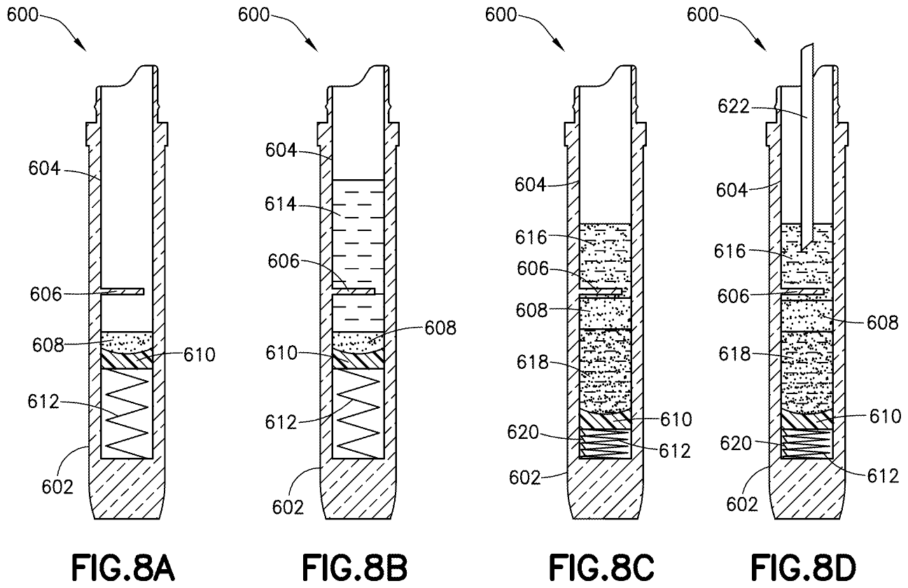

Referring now to FIGS. 8A-8D, a specimen collection container assembly 600 in accordance with another aspect of the present disclosure is shown. FIG. 8A illustrates the specimen collection container assembly 600 in a first pre-centrifugation condition. Specimen collection container assembly 600 includes a collection tube defined by an exterior sidewall 602 and an interior reservoir 604. The collection tube may be formed by, e.g., injection molding, from suitable plastic or composite material as is known to be suitable by those of ordinary skill in the art. A blocking member 606 extends from a fixed portion of an interior sidewall of the interior reservoir 604. As is shown in FIGS. 8A-8D, the blocking member 606 does not extend fully across the interior reservoir 604, thereby providing an opening through which fluid may pass.

The interior reservoir 604 further includes a moving floor 610, wherein moving floor 610 is axially movable within the interior reservoir 604 via a spring 612. A gel separator substance 608 is provided above the moving floor 610.

Referring to FIG. 8B, specimen collection container assembly 600 is shown in a second pre-centrifugal state, with a precisely measured collected blood sample 614 within the interior reservoir 604. Prior to centrifugation, the blood sample 614 collects above the gel separator substance 608 and the moving floor 610.

However, referring to FIG. 8C, upon centrifugation, the blood sample 614 separates into two primary component parts: a plasma/serum portion 616 and the hematocrit portion 618, with the denser hematocrit portion 618 being forced toward the bottom of the interior reservoir 604. Furthermore, with a density between that of the plasma/serum portion 616 and the hematocrit portion 618, centrifugation also causes both the gel separator substance 608 to migrate away from the moving floor 610, with the gel separator substance 608 settling in a location at an interface between the component parts of the blood sample to create a non-rigid barrier between the plasma/serum portion 616 and the hematocrit portion 618.

Referring still to FIG. 8C, centrifugation of the specimen collection container assembly 600 also causes the spring 612 to compress, thereby lowering the moving floor 610 into the interior reservoir 604. At this lowered location, a ratchet 620 is provided so as to hold the moving floor 610 position. The height at which the ratchet 620 retains the moving floor 610 is precisely calculated based on the volume of the blood sample 614, as a known volume of the blood sample 614 leads to a known volume (and, thus, a known transition point) between the plasma/serum portion 616, the gel separator substance 608, and the hematocrit portion 618. As shown in FIG. 8C, the position of the moving floor 610 is such that the blocking member 606 extending from the internal sidewall of the interior reservoir 604 is located at or near the transition between the plasma/serum portion 616 and the gel separator substance 608. In this way, the blocking member 606 provides an effective physical barrier to any component below the plasma/serum portion 616.

Referring to FIG. 8D, after centrifugation, a probe 622 may be utilized to obtain a sample from within the interior reservoir 604. As the desired sample is typically the plasma/serum portion 616, the blocking member 606 physically prevents access by the probe 622 beyond the plasma/serum portion 616, thereby protecting against the probe 622 inadvertently entering the hematocrit portion 618.

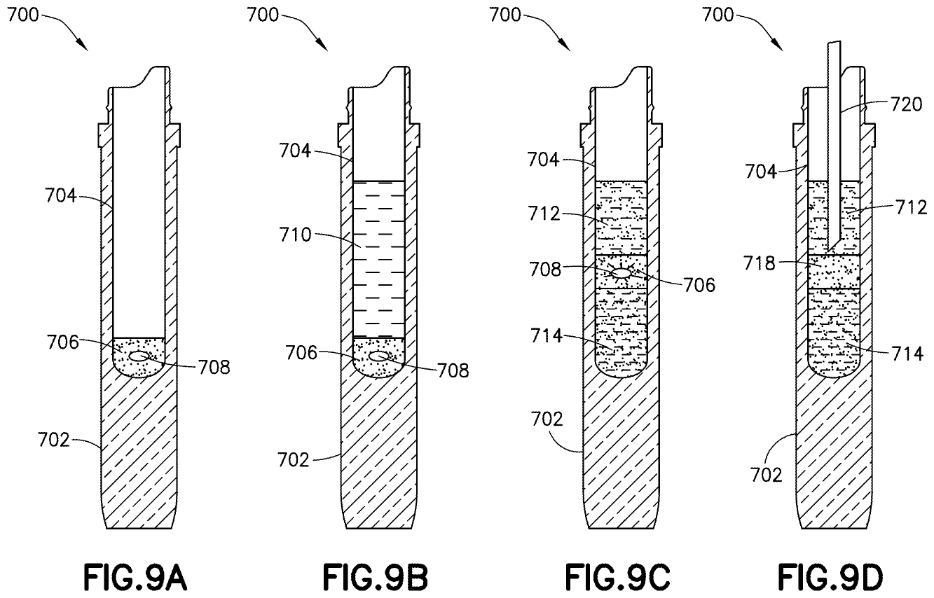

Referring now to FIGS. 9A-9D, a specimen collection container assembly 700 in accordance with another aspect of the present disclosure is illustrated. FIG. 9A shows the specimen collection container assembly 700 in a first pre-centrifugation condition. Specimen collection container assembly 700 includes a collection tube defined by an exterior sidewall 702 and an interior reservoir 704. The collection tube may be formed by, e.g., injection molding, from suitable plastic or composite material as is known to be suitable by those of ordinary skill in the art.

The interior reservoir 704 contains a gel separator substance 706 at a bottom portion thereof. Embedded within or on the gel separator substance 706 is a chemical tablet 708. When activated, the chemical within chemical tablet 708 is configured to act as a hardening agent for the gel separator substance 706, thereby converting the gel separator substance 706 from a gel consistency to a rigid consistency.

Referring to FIG. 9B, specimen collection container assembly 700 is shown in a second pre-centrifugal state, with a collected blood sample 710 within the interior reservoir 704. Prior to centrifugation, the blood sample 710 collects above the gel separator substance 706. However, referring to FIG. 9C, upon centrifugation, the blood sample 710 separates into two primary component parts: a plasma/serum portion 712 and the hematocrit portion 714, with the denser hematocrit portion 714 being forced to the bottom of the interior reservoir 704. Furthermore, with densities between that of the plasma/serum portion 712 and the hematocrit portion 714, centrifugation also causes the gel separator substance 706 to migrate away from the bottom portion of the interior reservoir 704, with the gel separator substance 706 settling in a location at an interface between the component parts of the blood sample to create a non-rigid barrier between the plasma/serum portion 712 and the hematocrit portion 714.

Additionally, referring still to FIG. 9C, centrifugation of the specimen collection container assembly 700 also results in activation/opening of the chemical tablet 708 due to, e.g., the agitation caused by centrifugation. As noted above, the activated chemical within chemical tablet 708 acts as a hardening agent for the gel separator substance 706, thereby converting the gel separator substance 706 into a rigid barrier member 718 between the plasma/serum portion 712 and the hematocrit portion 714, as is shown in FIG. 9D.

Also shown in FIG. 9D, after centrifugation, a probe 720 may be utilized to obtain a sample from within the interior reservoir 704. As the desired sample is typically the plasma/serum portion 716, the rigid barrier member 718 provides a physical barrier that prevents access by the probe 720 beyond the plasma/serum portion 716, thus protecting against the probe 720 inadvertently entering the hematocrit portion 714.

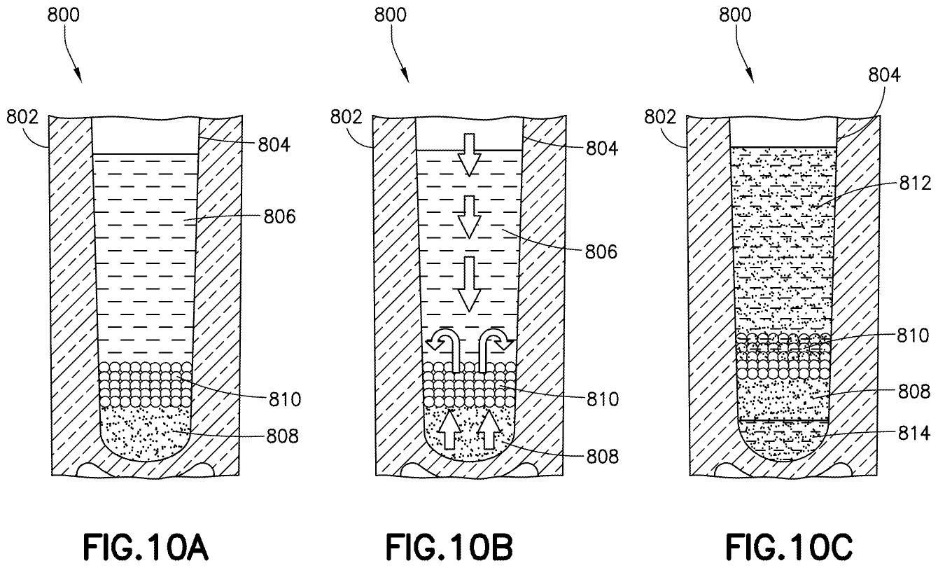

Referring now to FIGS. 10A-10C, a specimen collection container assembly 800 in accordance with another aspect of the present disclosure is illustrated. FIG. 10A shows the specimen collection container assembly 800 in a pre-centrifugation condition. Specimen collection container assembly 800 includes a collection tube defined by an exterior sidewall 802 and an interior reservoir 804. The collection tube may be formed by, e.g., injection molding, from suitable plastic or composite material as is known to be suitable by those of ordinary skill in the art.

The interior reservoir 804 contains a gel separator substance 808 at a bottom portion thereof. Additionally, above the gel separator substance 808, a plurality of microbeads 810 may be provided. In some embodiments, the microbeads 810 may be formed of, e.g., polystyrene. Additionally, in some embodiments, the microbeads 810 may range in size from 0.5 mm to 5 mm in diameter. The microbeads 810 may also have varied roughness, wettability, surface mobility, modulus, etc.

Referring still to FIG. 10A, a collected blood sample 806 is provided within the interior reservoir 804. Prior to centrifugation, the blood sample 806 collects above both the microbeads 810 and the gel separator substance 808.

FIG. 10B shows the specimen collection container assembly 800 during centrifugation, while FIG. 10C shows the specimen collection container assembly 800 after centrifugation. During centrifugation (FIG. 10B), the blood sample 806 separates into two primary component parts: a plasma/serum portion 812 and the hematocrit portion 814, with the denser hematocrit portion 814 being forced to the bottom of the interior reservoir 804 (as shown in FIG. 10C). Furthermore, with densities between that of the plasma/serum portion 812 and the hematocrit portion 814, centrifugation also causes the plurality of microbeads 810 and the gel separator substance 808 to migrate away from the bottom portion of the interior reservoir 804, with the plurality of microbeads 810 and the gel separator substance 808 settling in a location at an interface between the component parts of the blood sample to create an effective barrier between the plasma/serum portion 812 and the hematocrit portion 814.

In some embodiments, the plurality of microbeads 810 remain separate from the gel separator substance 808 after centrifugation. However, in other embodiments, at least a portion of the plurality of microbeads 810 are embedded into the gel separator substance 808 after centrifugation.

Furthermore, in some embodiments, the microbeads 810 may be stored in a cap (not shown) via a relatively loose-fitting connection. Upon centrifugation, the microbeads 810 may be released from the cap and into the blood sample 806.

While not shown, a probe is typically utilized to obtain a sample from within the interior reservoir 804. As the desired sample is typically the plasma/serum portion 812, the plurality of microbeads 810 provide a physical barrier that prevents access by the probe beyond the plasma/serum portion 812, thus protecting against the probe inadvertently entering the hematocrit portion 814.

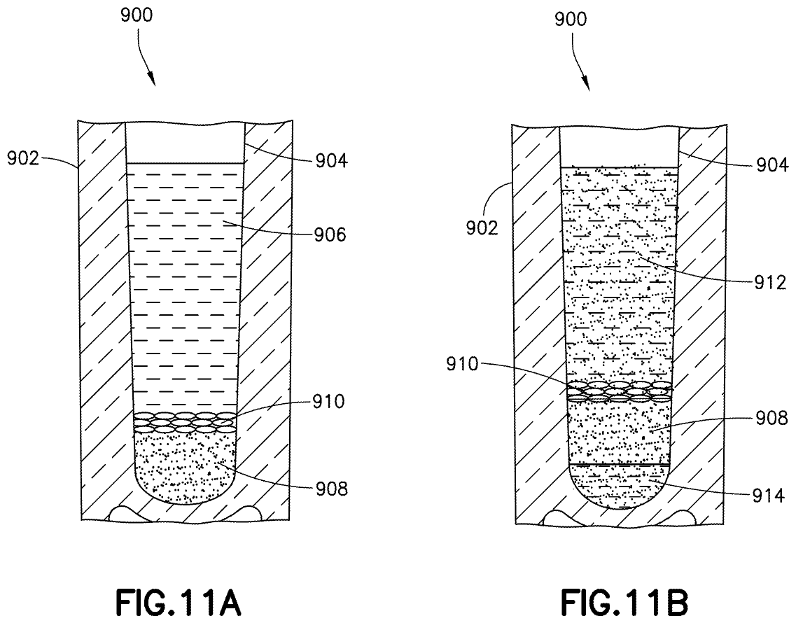

With reference to FIGS. 11A and 11B, a specimen collection container assembly 900 in accordance with another aspect of the present disclosure is illustrated. FIG. 11A shows the specimen collection container assembly 900 in a pre-centrifugation condition. Specimen collection container assembly 900 includes a collection tube defined by an exterior sidewall 902 and an interior reservoir 904. The collection tube may be formed by, e.g., injection molding, from suitable plastic or composite material as is known to be suitable by those of ordinary skill in the art.

The interior reservoir 904 contains a gel separator substance 908 at a bottom portion thereof. Additionally, above the gel separator substance 908, a plurality of micropellets 910 may be provided. In some embodiments, the micropellets 910 may be formed of, e.g., polystyrene. Additionally, in some embodiments, the microbeads 910 may range in size from 0.5 mm to 5 mm in length. The microbeads 910 may also have varied roughness, wettability, surface mobility, modulus, etc.

Referring still to FIG. 11A, a collected blood sample 906 is provided within the interior reservoir 904. Prior to centrifugation, the blood sample 906 collects above both the micropellets 910 and the gel separator substance 908.

FIG. 11B shows the specimen collection container assembly 900 after centrifugation. Upon centrifugation, the blood sample 906 separates into two primary component parts: a plasma/serum portion 912 and the hematocrit portion 914, with the denser hematocrit portion 914 being forced to the bottom of the interior reservoir 904 (as shown in FIG. 11B). Furthermore, with densities between that of the plasma/serum portion 912 and the hematocrit portion 914, centrifugation also causes the plurality of micropellets 910 and the gel separator substance 908 to migrate away from the bottom portion of the interior reservoir 904, with the plurality of micropellets 910 and the gel separator substance 908 settling in a location at an interface between the component parts of the blood sample to create an effective barrier between the plasma/serum portion 912 and the hematocrit portion 914.

In some embodiments, the plurality of micropellets 910 remain separate from the gel separator substance 908 after centrifugation. However, in other embodiments, at least a portion of the plurality of micropellets 910 are embedded into the gel separator substance 908 after centrifugation.

Furthermore, in some embodiments, the micropellets 910 may be stored in a cap (not shown) via a relatively loose-fitting connection. Upon centrifugation, the micropellets 910 may be released from the cap and into the blood sample 906.

While not shown, a probe is typically utilized to obtain a sample from within the interior reservoir 904. As the desired sample is typically the plasma/serum portion 912, the plurality of micropellets 910 provide an effective physical barrier that prevents access by the probe beyond the plasma/serum portion 912, thus protecting against the probe inadvertently entering the hematocrit portion 914.

While several embodiments of a device for the collection of blood samples incorporating a rigid barrier were described in the foregoing detailed description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are embraced within their scope.

What is claimed is:

1. A specimen collection container assembly comprising:
a collection tube;
an interior reservoir formed within the collection tube;
a gel separation substance provided within the interior reservoir; and
a rigid barrier member provided within the interior reservoir,
wherein upon collection of a specimen within the interior reservoir and centrifugation of the collection tube, the specimen is divided into two primary component parts, and the gel separation substance and the rigid barrier member migrate to a transition location between the two primary component parts so as to form a physical barrier between a first component part of the specimen and a second component part of the specimen.

2. The assembly of claim 1, wherein the rigid barrier member comprises a floating barrier.

3. The assembly of claim 2, wherein the buoyancy of the floating barrier is equal to the buoyancy of the gel separation substance.

4. The assembly of claim 1, wherein the rigid barrier member comprises a convex upper surface and a concave lower surface.

5. The assembly of claim 4, wherein the rigid barrier member is configured to contact an internal sidewall of the interior reservoir when the convex upper surface is contacted by a probe member.

6. The assembly of claim 1, wherein the rigid barrier member comprises a one-way valve.

7. The assembly of claim 6, wherein the one-way valve is configured to close when contacted by a probe member.

8. The assembly of claim 1, wherein the rigid barrier member further comprises a locking member.

9. The assembly of claim 8, wherein the locking member retracts when subjected to a centrifugal force.

10. The assembly of claim 1, wherein the rigid barrier member is formed of a plurality of microbeads.

11. The assembly of claim 1, wherein the rigid barrier member is formed of a plurality of micropellets.

12. A specimen collection container assembly comprising:
a collection tube;
an interior reservoir formed within the collection tube;
a gel separation substance provided within the interior reservoir; and
a rigid barrier member,
wherein upon collection of a specimen within the interior reservoir and centrifugation of the collection tube, the specimen is divided into two primary component parts, the gel separation substance migrates to a transition location between the two primary component parts, and the rigid barrier member is moved to the transition location so as to form a physical barrier between a first component part of the specimen and a second component part of the specimen.

13. The assembly of claim 12, wherein the rigid barrier member is moved to the transition location by a plunger rod.

14. The assembly of claim 13, wherein the plunger rod is configured to pass at least partially through a cap, and wherein the cap is selectively couplable to the collection tube.

15. The assembly of claim 13, wherein the rigid barrier member comprises at least one opening formed therethrough.

16. The assembly of claim 12, wherein the rigid barrier member is moved to the transition location by a threaded rod.

17. The assembly of claim 16, wherein the threaded rod is configured to axially move via rotation of a cap, and wherein the cap is selectively couplable to the collection tube.

18. The assembly of claim 12, wherein the rigid barrier member is moved to the transition location by a probe.

19. The assembly of claim 12, further comprising a rotatable floor member coupled to the collection tube, a threaded screw member operably coupled to the rotatable floor member, and a plate member coupled to an end of the threaded screw member, wherein the plate member is configured to act as the rigid barrier member.

20. A specimen collection container assembly comprising:
a collection tube;
an interior reservoir formed within the collection tube;
a gel separation substance provided within the interior reservoir;
a fixed, rigid barrier member extending from an internal sidewall of the interior reservoir; and
a spring-loaded moving floor provided in a bottom portion of the interior reservoir,
wherein upon collection of a specimen within the interior reservoir and centrifugation of the collection tube, the specimen is divided into two primary component parts, the gel separation substance migrates to a transition location between the two primary component parts, and the spring-loaded moving floor moves downward within the interior reservoir such that the fixed, rigid barrier member is positioned at the transition location between a first component part of the specimen and a second component part of the specimen.

21. The assembly of claim 20, wherein the spring-loaded moving floor is held in a fixed position after centrifugation by a ratchet member.

22. A specimen collection container assembly comprising:
a collection tube;
an interior reservoir formed within the collection tube;
a gel separation substance provided within the interior reservoir; and
a chemical tablet provided within the interior reservoir, the chemical tablet comprising a hardening agent,
wherein upon collection of a specimen within the interior reservoir and centrifugation of the collection tube, the specimen is divided into two primary component parts, the gel separation substance migrates to a transition location between the two primary component parts, and the hardening agent within the chemical tablet activates and interacts with the gel separation substance to form a rigid barrier member at the transition location between a first component part of the specimen and a second component part of the specimen.
